(19) United States
(12) Patent Application Publication
(10) Pub. No.: US 2012/0011452 A1
(43) Pub. Date: Jan. 12, 2012

(54) METHOD OF PORTABLE ELECTRONIC DEVICE SUPPORT IN DISPLAY UNIT

(75) Inventors: Alok DWIVEDI, Noida (IN); Ranjeet Singh DEVGUN, Delhi (IN)

(73) Assignee: SAMSUNG ELECTRONICS CO., LTD., Suwon-si (KR)

(21) Appl. No.: 13/177,015

(22) Filed: Jul. 6, 2011

(30) Foreign Application Priority Data
Jul. 6, 2010 (IN) 1912/CHE/2010

(51) Int. Cl. G06F 3/01; G06F 15/16

(52) U.S. Cl. 715/753

(57) ABSTRACT

In accordance with an embodiment of the invention, a system for communicating in an interactive session is provided. The system includes a display unit configured to display information received from an input device. The system also includes a plurality of portable electronic devices communicatively coupled to the display unit wherein, the display unit is configured to share data received from a plurality of audiences during the interactive session.

### CROSS-REFERENCE TO RELATED APPLICATION

This application claims priority from Indian Patent Application No. 1912/CHE/2010 filed on Jul. 6, 2011 in the in the Intellectual Property India, the disclosure of which is incorporated herein in its entirety by reference.

### FIELD OF INVENTION

This invention relates to communication systems, more particularly, to a system for human interaction with portable electronic devices.

### BACKGROUND

Conventionally, interactive sessions, for example presentations, seminars, and lectures include a presenter and multiple audiences. Generally, the presenter presents information on a display unit and the multiple audience use a portable electronic device such as a portable electronic display device to view the information. In a non limiting example the portable electronic display device includes e-pads, laptops.

Typically, the multiple audiences are unable to interact among themselves during the presentation. The multiple audience need to submit their notes made during the presentation to the presenter for compilation and distribution after the presentation. The distribution creates a time lag for providing suggestions and comments to the multiple audience. This results in duplicity of suggestions and comments. Furthermore, there is no real time interaction between the multiple audiences during the presentation to exchange their views, suggestions and comments to derive maximum benefit from the information presented.

Hence, there is a need for a system and a method to address the aforementioned issues.

### SUMMARY

In accordance with an embodiment of the invention, a system for communicating in an interactive session is provided. The system includes a display unit configured to display information received from an input device. The system also includes a plurality of portable electronic devices communicatively coupled to the display unit wherein, the display unit is configured to share data received from a plurality of audiences during the interactive session.

In accordance with another embodiment of the invention, a method for communicating in an interactive session is provided. The method includes receiving information from an input device. The method also includes displaying the information on a display unit. The method further includes receiving the information from a plurality of portable electronic devices. The method also includes configuring the display unit to share data received from a plurality of audiences during the interactive session.

### BRIEF DESCRIPTION OF FIGURES

FIG. 1 is a schematic representation of a system 100 for communicating in an interactive session

FIG. 2 is a schematic representation of the plurality of portable electronic devices.

FIG. 3 depicts a display unit in an interaction mode.

FIG. 4 depicts the display unit in a split screen mode.

FIG. 5. is a block diagram for communicating in the interactive session.

### DETAILED DESCRIPTION

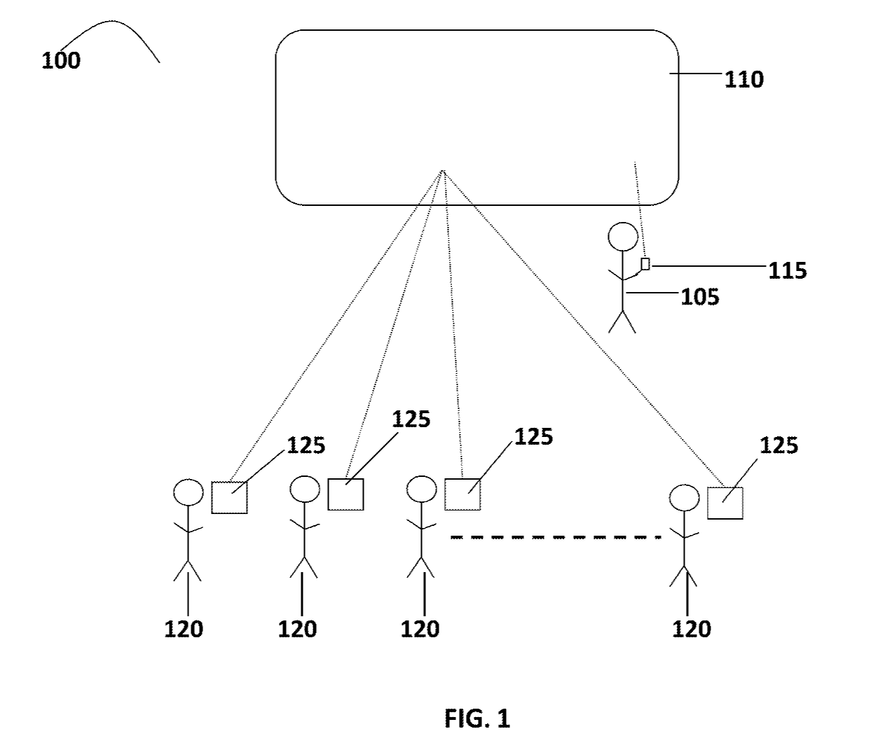

FIG. 1 is a schematic representation of a system 100 for communicating in an interactive session in accordance with an embodiment of the invention. In a non limiting example the interactive session includes lectures, seminars, presentations and conferences. Generally, the interactive session includes a presenter 105 that inserts information into an input device (not shown).

The input device transmits the information to a display unit 110 based upon a control signal sent by the presenter 105 using a display unit remote controller 115. In an embodiment of the invention the display includes a digital television. The display unit 110 displays the information to the multiple audiences 120, provided by the presenter 105. The display unit 110 further receives the information from multiple portable electronic devices 125. In an embodiment multiple portable electronic devices include e-pad.

Furthermore, the presenter activates an interactive mode using the display unit remote controller 115. The interactive mode enables the multiple audiences 120 to share data to the display unit 110 in real time during the interactive session. In an embodiment of the invention the data includes drawings, views, suggestions and comments in a written form. The multiple audiences 120 use the portable electronic devices 125 to sketch drawings, type alphabets or write suggestions, views and comments. The data is shared among the multiple audiences 120 by displaying the data on the display unit 110. This facilitates the multiple audiences 120 to view different data provided by the multiple audiences 120 simultaneously during the interactive session.

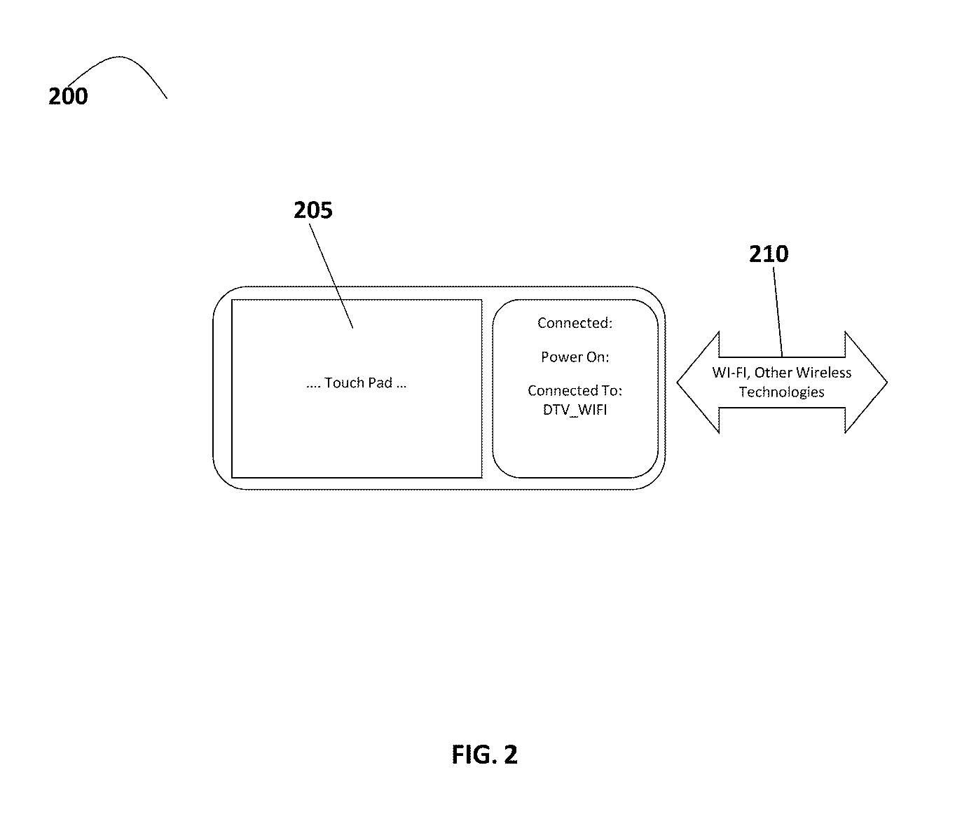

FIG. 2 is a schematic representation of the plurality of portable electronic devices 200 employed in the system for communicating in an interactive session in accordance with an embodiment of the invention.

The plurality of portable electronic devices 200 includes a touch pad 205 for providing data to the display unit. In an embodiment of the invention the plurality of portable electronic device 200 includes the e-pad. The portable electronic devices 200 are communicatively coupled with the display unit via wireless communication 210. In an exemplary example wireless includes Wi-Fi or infrared communication.

Furthermore, the plurality of portable electronic devices 200 shares the data in the interaction mode. In an embodiment of the invention the data includes drawing, views, suggestions and comments of the plurality of audiences.

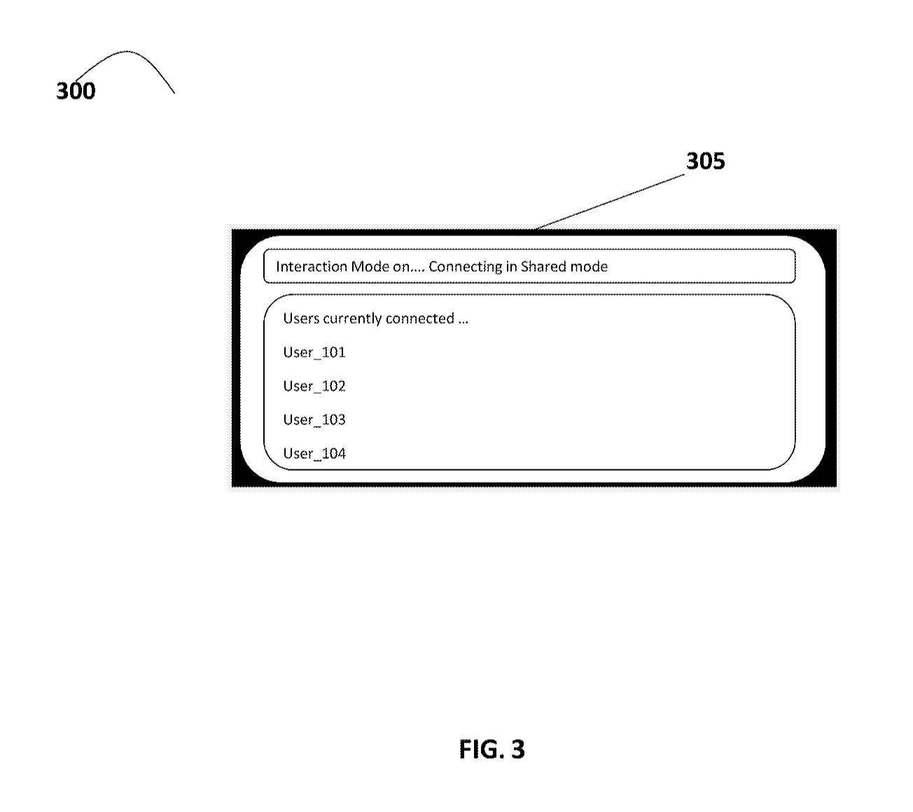

FIG. 3 depicts a display unit in an interaction mode 300 configured to display the information from an input device.

In an embodiment of the invention display unit 305 includes a display used for a plurality of audiences. The display unit 305 is communicatively coupled with the plurality of portable electronic devices via wireless communication. In another embodiment of the invention the wireless communication includes Wi-Fi and infrared communication.

Furthermore, the interactive session is activated in the display unit 305 by the remote controller. The remote controller is communicatively coupled with display unit 305 via wireless communication. In an embodiment of the invention wireless communication includes Wi-Fi and infrared communication.

In an embodiment of the invention the display unit 305 displays the portable electronic devices connected with the display unit.

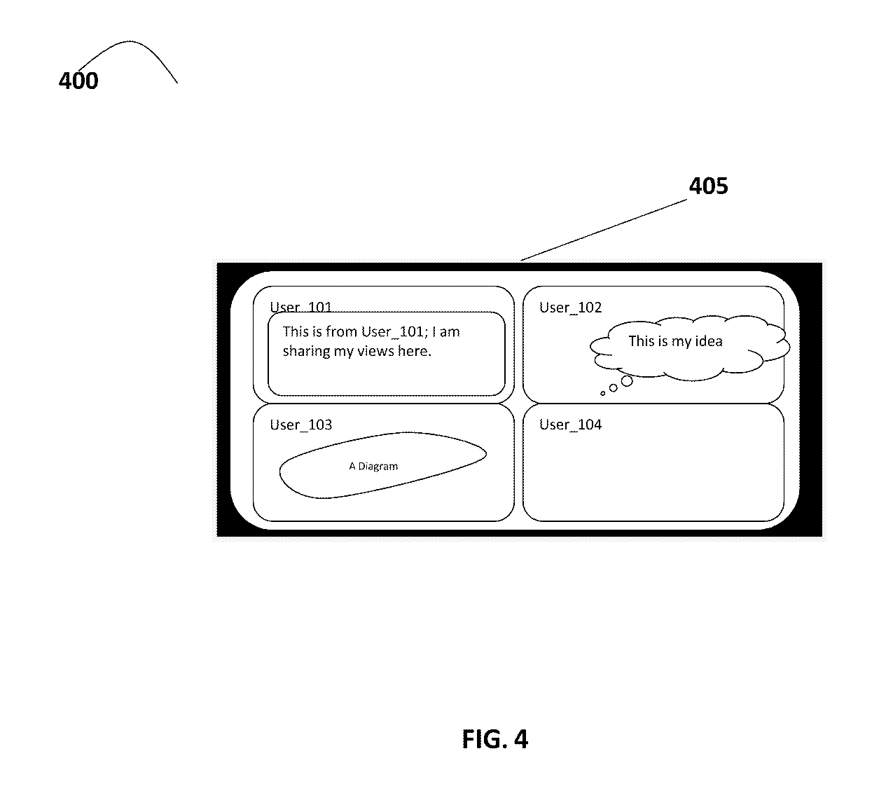

FIG. 4 depicts the display unit 405 in a split screen mode. In an embodiment of the invention display unit 405 includes the display used for multiple audiences. The display unit 405 is communicatively coupled with the plurality of portable electronic devices via wireless communication. In another embodiment of the invention the wireless communication includes Wi-Fi and infrared communication.

Furthermore, the interactive session is activated in the display unit 405 by the remote controller. The remote controller is communicatively coupled with display unit 405 via wireless communication. In an embodiment of the invention wireless communication includes Wi-Fi and infrared communication.

Further the display unit 405 in the split screen mode displays the data shared by the plurality of audiences. In an embodiment the data includes drawings, views, suggestions and comments.

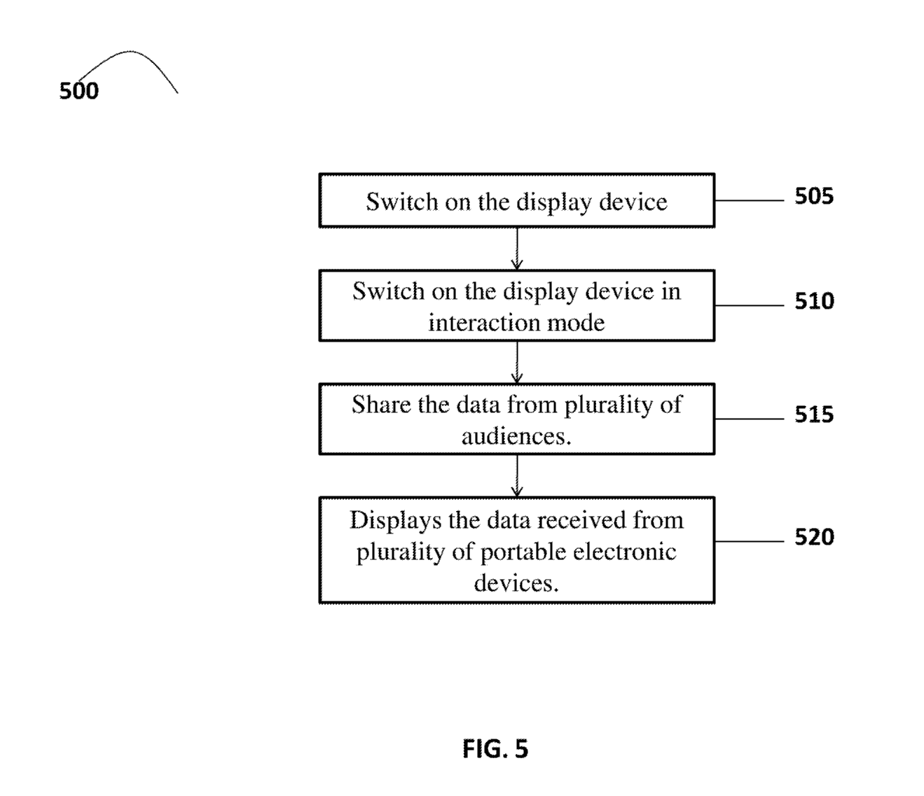

FIG. 5. is a block diagram for communicating in an interactive session 500.

At Step 505 the display device is switched on. The presenter gives the command to run the input device. The display device receives the information from the input device and displays the same in front of the plurality of audiences.

Further the remote controller is used to change the mode of the display device into interaction mode in Step 510. The device displays the plurality of portable electronic device connected to the device. The plurality of portable electronic devices is communicatively couple with the display device with a wireless communication. In an embodiment the wireless communication includes Wi-Fi communication or infrared communication.

At Step 515 the plurality of audiences shares the data to the display unit. In an embodiment the data includes one or more drawings, views, suggestions and comments of the plurality of audiences.

At Step 520 the display device receives the data from the plurality of portable electronic devices. Further the display unit displays the received data from the plurality of portable electronic devices.

The present invention may, of course, be carried out in other specific ways than those herein set forth without departing from the spirit and essential characteristics of the invention. The present embodiments are, therefore, to be considered in all respects as illustrative and not restrictive, and all changes coming within the meaning and equivalency range of the appended claims are intended to be embraced therein.

I/We claim:

1. A system for communicating in an interactive session comprising:
a display unit configured to display an information received from an input device; and
a plurality of portable electronic devices communicatively coupled to the display unit wherein, the display unit is configured to share data received from the plurality of portable electronic devices during the interactive session.

2. The system according to claim 1, wherein the display unit comprises a display to display the information received from the input device.

3. The system according to claim 1, wherein the plurality of portable electronic devices comprises e-pads.

4. The system according to claim 1, wherein the display unit receives the information from the plurality of portable electronic devices.

5. The system according to claim 1, wherein the plurality of portable electronic devices shares the data in an interaction mode.

6. The system according to claim 5, wherein the interaction mode is activated via a display unit remote controller.

7. The system according to claim 5, wherein the plurality of portable electronic devices interact by a wireless communication.

8. The system according to claim 6, wherein the wireless communication comprises infrared communication or Wi-Fi communication.

9. The system according to claim 1, wherein the data comprises one or more drawings, views, suggestions and comments received from the plurality of portable electronic devices.

10. The system according to claim 1, wherein the interactive session comprises lectures, seminars, conferences and presentations.

11. The system according to claim 1, wherein the display unit is communicatively coupled to the plurality of portable electronic devices via the display unit remote controller.

12. A method for communicating in an interactive session comprising:
receiving information from an input device;
displaying the information on a display unit;
receiving the information from a plurality of portable electronic devices; and
configuring the display unit to share data received from a plurality of audiences during the interactive session.

13. The method according to claim 12, further comprising activating an interaction mode via a display unit remote controller.

14. The method according to claim 12, further comprising interacting between the plurality of portable electronic devices and the display unit via wireless communication.

15. The method according to claim 14, wherein interacting between the plurality of portable electronic devices and the display unit further comprising sharing the data from a plurality of portable electronic devices.

16. The method according to claim 15, wherein sharing the data between the plurality of portable electronic devices comprises receiving and displaying one or more drawings, views, suggestions and comments of the plurality of portable electronic devices.
